(19) United States
(12) Patent Application Publication
(10) Pub. No.: US 2012/0317640 A1
(43) Pub. Date: Dec. 13, 2012

(54) VARIABLE LENGTH, MULTIDIMENSIONAL AUTHENTICATION KEYS

(75) Inventor: Amer HAMMOUD, Ottawa (CA)

(73) Assignee: INTERNATIONAL BUSINESS MACHINES CORPORATION, Armonk, NY (US)

(21) Appl. No.: 13/157,082

(22) Filed: Jun. 9, 2011

(51) Int. Cl. G06F 21/00

(52) U.S. Cl. 726/19

(57) ABSTRACT

Provided are techniques for determining access to a secure system. A portion of an input sequence is received. A security factor of the received portion of the input sequence is determined by calculating: P(is)*P(gu), where P(is) is a probability of the input sequence being a valid password, and where P(gu) is a probability of a gesture pertaining to a user based on historical data collected from the user. It is determined whether the security factor has reached a predetermined level. In response to determining that the security factor has reached the predetermined level, access to the secure system is allowed before the entire input sequence is received.

### BACKGROUND

Embodiments of the invention relate to variable length, multidimensional authentication keys.

A password may be described as a string of characters used to access a secure system. The strength of a password (“password strength”) may be described as a measure of the effectiveness of a password in resisting guessing and brute-force attacks. The password strength increases with the length of the password. However, long passwords take a long time to type and may be difficult to remember, and so users avoid using long passwords.

Some secure systems utilize biometric identification for access. Biometric identification may be based on face, iris and retinal patterns, hand geometry and voice.

### SUMMARY

Provided are a method, computer program product, and system for determining access to a secure system. A portion of an input sequence is received. A security factor of the received portion of the input sequence is determined by calculating: P(is)*P(gu), where P(is) is a probability of the input sequence being a valid password, and where P(gu) is a probability of a gesture pertaining to a user based on historical data collected from the user. It is determined whether the security factor has reached a predetermined level. In response to determining that the security factor has reached the predetermined level, access to the secure system is allowed before the entire input sequence is received.

### BRIEF DESCRIPTION OF THE SEVERAL VIEWS OF THE DRAWINGS

Referring now to the drawings in which like reference numbers represent corresponding parts throughout:

FIG. 1 illustrates, in a block diagram, a computing device with a Variable Length, Multidimensional Authentication (VLMA) system in accordance with certain embodiments.

FIG. 2 illustrates, in a flow diagram, logic for determining a security factor based on multiple dimensions in accordance with certain embodiments.

FIG. 3 illustrates, in a block diagram, a computer architecture that may be used in accordance with certain embodiments.

### DETAILED DESCRIPTION

In the following description, reference is made to the accompanying drawings which form a part hereof and which illustrate several embodiments of the invention. It is understood that other embodiments may be utilized and structural and operational changes may be made without departing from the scope of the invention.

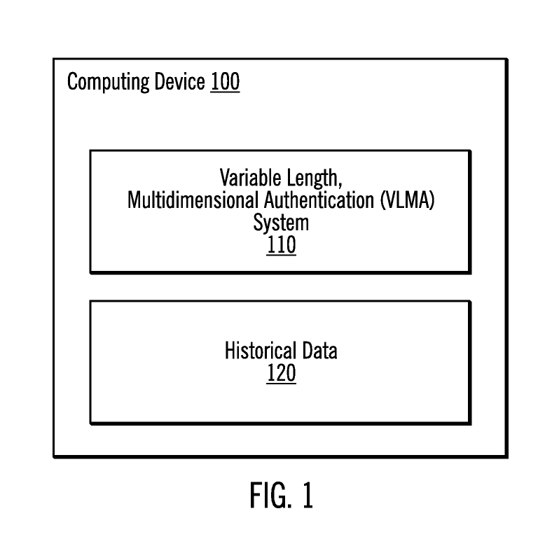

FIG. 1 illustrates, in a block diagram, a computing device 100 with a Variable Length, Multidimensional Authentication (VLMA) system 110 in accordance with certain embodiments. The computing device 100 also includes historical data 120 collected from users.

The VLMA system 110 makes the usage of long textual or graphical passwords easier by incorporating another dimension (i.e., a second dimension) into the password. The first dimension pertains to characters of the password entered in the proper order. The second dimension pertains to the dynamics with which the password has been entered, such as keystroke dynamics, timing, or acceleration of gestures, etc. The VLMA system 110 factors the probability of the second dimension against the historical data 120 collected from the user with that of the probability of the first dimension, and, when an predetermined (e.g., acceptable) combined security factor is reached, the VLMA system 110 grants access before the entire password is typed in by a user (i.e., without the user having to submit the entire password).

The VLMA system 110 uses the second dimension to shorten the required length of the password when it deems that the combined password strength of the two dimensions has reached an acceptable, predetermined password strength, and, thus, the entire password does not need to be typed in before access is granted, but only the 1^{st} n characters of the password, where n can vary depending on the dynamics with which the password has been entered. so different portions of the password may be typed in at different times before access is granted.

In order to be able to access a secure system, the administrator of that system requires a certain security factor. In certain embodiments, a security factor may be described as password strength.

The VLMA system 110 continuously calculates the security factor of an input key while the user is keying in or gesturing a password. A gesture may be described as a form of non-verbal communication in which visible bodily actions communicate the password, either in place of spoken words or together with spoken words. Gestures include movement of the hands, face, or other parts of the body. For example, a user could use a hand to move a mouse to scribble a password or input a series of motions representing the password. Also, a user can use the body to form one or more gestures to communicate passwords to a device, In certain embodiments, the way in which a user types may also be considered a type of gesturing input. When an acceptable, predetermined security factor has been reached, the VLMA system 110 grants access. In certain embodiments, the VLMA system 110 calculates the security factor with Equation (1):

Security Factor=P(is)*P(gu) Equation (1)

where P(is) is a probability of an input sequence being a valid password, and
P(gu) is a probability of a gesture pertaining to user based on historical data for that user.

In certain embodiments, the VLMA system 110 calculates the probability of the input sequence with Equation (2):

P(is)=N̂L Equation (2)

where N is a number of letters in a language, and L is a length of the input sequence.

In certain embodiments, the VLMA system 110 converts the probability of the input sequence to bits to measure password bit strength using Equation (3):

P(is)=L*log(N)/log(2) Equation (3)

In certain embodiments, the VLMA system 110 calculates the probability of the gesture pertaining to the user by comparing the ratios of the different keystrokes, keystroke transitions, dwell times (i.e., how long a key is pressed), and/or gestures to the historical data 120 collected from the user (e.g., during one or more previous times that the user entered this input sequence or any other input sequence). In certain embodiments, the VLMA system 110 identifies the user and obtains the historical data for that user based on a received user name or other identifier.

For example, if the VLMA system 110 is doing this for a keyboard input, the VLMA system 110 calculates the probability of the gesture pertaining to the user using Equation (4):

P(gu)=P(gu[i])*P(gu[i+1]) . . . *P(gu[n]) Equation (4)

where n is a current key stroke,
where P(gu[i])=(Input_Range)/(abs(Mean_Authenticated_Input[i]−Current[i])+1),
where Input_Range is a normal time range for a particular keying gesture in users,
where Mean_Authenticated_Input[i] is a mean of successes in previous attempts keying this particular portion of the input sequence, and
where Current[i] is an actual time for keying this particular portion of the input sequence.

Thus, based on P(gu), the smaller the difference with historical successful gestures, the highest the probability of a password being keyed in by a legitimate user.

Merely to enhance understanding of embodiments, an example will be provided herein. Assume that a password is: big_long_huge_password.
L=22.
N=26.
P(is)=26̂22=13471428653161560586981973426176.
P(is)=log(13471428653161560586981973426176)/log(2)=103 bits.
Assume for simplicity that the time range for typing each key is 150 milliseconds (ms).
Assume the mean for the user typing the sequence is: b(100)i(50)g(60)_(65) . . . etc.
Assume the actual time is: b(98)i(53)g(66)_(70) . . . etc.
P(gu)=150/(abs(100−98)+1)*150/(abs(50−53)+1)*150/(abs(60−66)+1)*150/(abs(65−70)+1) . . . etc.

Thus, by the time the user has typed 4 keys (i.e., the characters “big_” for this example), the user has reached a security factor of:

P(is)*P(gu)=(26̂4)*(50*37.5*22*25)=456976*1031250=471256500000.

The security factor of 471256500000 is 38 bits, as opposed to 26̂4=456976=18 bits. So, at this rate, the user may secure access by the time the user types the 10th key as opposed to the 22nd key.

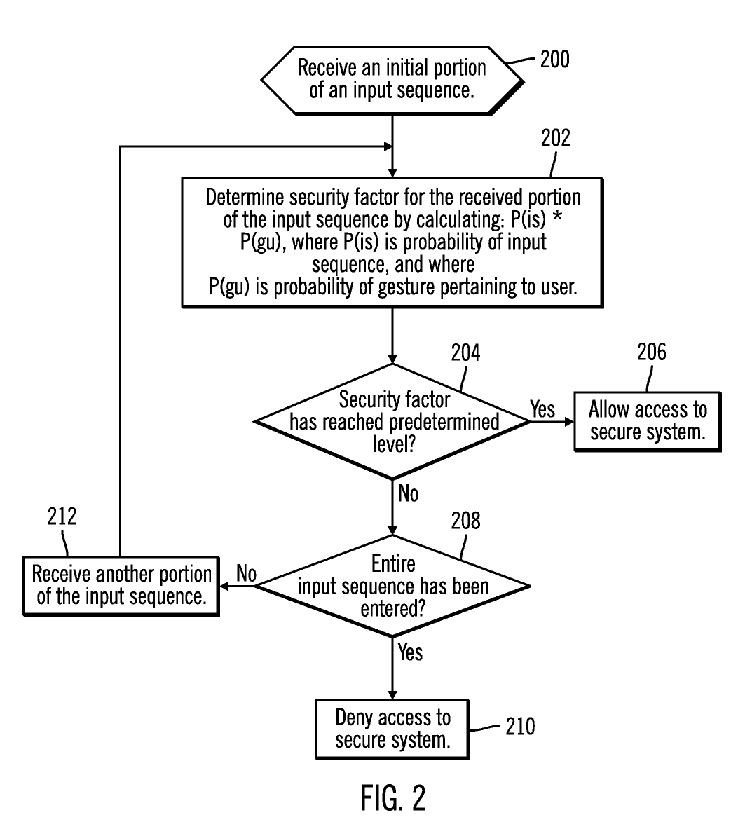

FIG. 2 illustrates, in a flow diagram, logic for determining a security factor based on multiple dimensions in accordance with certain embodiments. Control begins with the VLMA system 110 receiving an initial portion of an input sequence (e.g., a first character or graphic of a password). In block 202, the VLMA system 110 determines the security factor of the received portion of the input sequence by calculating: P(is)*P(gu), where P(is) is a probability of input sequence, and where P(gu) is a probability of a gesture pertaining to the user. In block 204, the VLMA system 110 determines whether the security factor has reached a predetermined level. If so, processing continues to block 206, otherwise, processing continues to block 208. In certain embodiments, the predetermined level may be configured by a system administrator or other user.

In block 206, the VLMA system 110 allows access to a secure system. Thus, a user may be granted access to the secure system after entering a portion of an input sequence (e.g., a password).

In block 208, the VLMA system 110 determines whether the entire input sequence has been entered (i.e., whether the user has completed entering the input sequence). If so, processing continues to block 210, otherwise, processing continues to block 212. The determination of whether the user has completed entering the input sequence may be made based on, for example, user action (e.g., user selection of an “enter” key of a keyboard).

In block 210, the VLMA system 110 denies access to secure system. That is, if the VLMA system 110 determines that the user has completed entering the input sequence, and the security factor of the input sequence has not reached the predetermined level, then access is denied to the user.

In block 212, the VLMA system 110 receives another portion of the input sequence. From block 212, processing loops back to block 202.

The VLMA system 110 may be applied to a ratio of one input to a next input or any other variable that can be measured that pertains to the user's actions (e.g., mouse acceleration between graphical gestures, transition times, angles, curvature, etc.)

Thus, the VLMA system 110 enables system access by a user inputting a keyword by continuously calculating a security factor and allowing access when a predetermined security factor level has been reached, where the security factor is a combination of the probability of that the keyword is a valid password with the probability that the inputting is done by an authorized user. The probability that the inputting is done by an authorized user is calculated by comparing the ratios of the different keystrokes, keystroke transitions, dwell times, and/or gestures to historical data previously collected from the authorized user.

### Additional Embodiment Details

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, solid state memory, magnetic tape or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as portion of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the embodiments of the invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational processing (e.g., operations or steps) to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The code implementing the described operations may further be implemented in hardware logic or circuitry (e.g., an integrated circuit chip, Programmable Gate Array (PGA), Application Specific Integrated Circuit (ASIC), etc. The hardware logic may be coupled to a processor to perform operations.

The Variable Length, Multidimensional Authentication (VLMA) system 110 may be implemented as hardware (e.g., hardware logic or circuitry), software, or a combination of hardware and software.

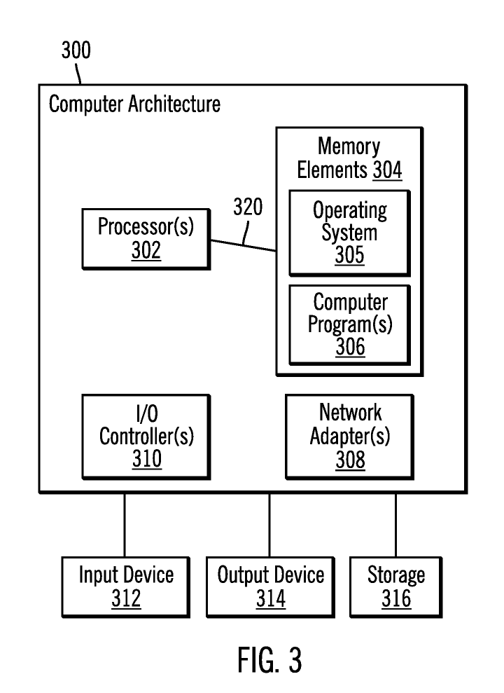

FIG. 3 illustrates a computer architecture 300 that may be used in accordance with certain embodiments. Computing device 100 may implement computer architecture 300. The computer architecture 300 is suitable for storing and/or executing program code and includes at least one processor 302 coupled directly or indirectly to memory elements 304 through a system bus 320. The memory elements 304 may include local memory employed during actual execution of the program code, bulk storage, and cache memories which provide temporary storage of at least some program code in order to reduce the number of times code must be retrieved from bulk storage during execution. The memory elements 304 include an operating system 305 and one or more computer programs 306.

Input/Output (I/O) devices 312, 314 (including but not limited to keyboards, displays, pointing devices, etc.) may be coupled to the system either directly or through intervening I/O controllers 310.

Network adapters 308 may also be coupled to the system to enable the data processing system to become coupled to other data processing systems or remote printers or storage devices through intervening private or public networks. Modems, cable modem and Ethernet cards are just a few of the currently available types of network adapters 308.

The computer architecture 300 may be coupled to storage 316 (e.g., a non-volatile storage area, such as magnetic disk drives, optical disk drives, a tape drive, etc.). The storage 316 may comprise an internal storage device or an attached or network accessible storage. Computer programs 306 in storage 316 may be loaded into the memory elements 304 and executed by a processor 302 in a manner known in the art.

The computer architecture 300 may include fewer components than illustrated, additional components not illustrated herein, or some combination of the components illustrated and additional components. The computer architecture 300 may comprise any computing device known in the art, such as a mainframe, server, personal computer, workstation, laptop, handheld computer, telephony device, network appliance, virtualization device, storage controller, etc.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The foregoing description of embodiments of the invention has been presented for the purposes of illustration and description. It is not intended to be exhaustive or to limit the embodiments to the precise form disclosed. Many modifications and variations are possible in light of the above teaching. It is intended that the scope of the embodiments be limited not by this detailed description, but rather by the claims appended hereto. The above specification, examples and data provide a complete description of the manufacture and use of the composition of the embodiments. Since many embodiments may be made without departing from the spirit and scope of the invention, the embodiments reside in the claims hereinafter appended or any subsequently-filed claims, and their equivalents.

1. A computer-implemented method for determining access to a secure system, comprising:
receiving a portion of an input sequence;
determining a security factor of the received portion of the input sequence by calculating:
P(is)*P(gu),
where P(is) is a probability of the input sequence being a valid password, and
where P(gu) is a probability of a gesture pertaining to a user based on historical data collected from the user;
determining whether the security factor has reached a predetermined level; and
in response to determining that the security factor has reached the predetermined level, allowing access to the secure system before the entire input sequence is received.

2. The method of claim 1, further comprising:
determining the probability of the input sequence by calculating:
P(is)=N̂L
where N is a number of letters in a language, and L is a length of the input sequence.

3. The method of claim 1, wherein the probability of the gesture pertaining to the user is calculated by comparing ratios of at least one of different keystrokes, keystroke transitions, dwell times, and gestures to the historical data collected from the user.

4. The method of claim 1, further comprising:
determining the probability of the gesture pertaining to the user by calculating:
P(gu)=P(gu[i])*P(gu[i+1]) . . . *P(gu[n])
where n is a current key stroke,
where P(gu[i])=(Input_Range)/abs(diff(Mean_Authenticated_Input[i]−Current[i]+1),
where Input_Range is a normal time range for a particular keying gesture in users,
where Mean_Authenticated_Input[i] is a mean of successes in previous attempts keying this particular portion of the input sequence, and
where Current[i] is an actual time for keying this particular portion of the input sequence.

5. The method of claim 1, further comprising:
in response to determining that the security factor has not reached the predetermined level,
receiving another portion of the input sequence;
determining a new security factor of the received portion of the input sequence; and
in response to determining that the new security factor has reached the predetermined level, allowing access to the secure system before the entire input sequence is received.

6. The method of claim 1, further comprising:
determining that an entire input sequence has been entered and that the security factor for the entire input sequence has not reached the predetermined level; and
denying access to the secure system.

7. A system for determining access to a secure system, comprising:
a processor; and
a Variable Length, Multidimensional Authentication (VLMA) system coupled to the processor and performing operations, the operations comprising:
receiving a portion of an input sequence;
determining a security factor of the received portion of the input sequence by calculating:
P(is)*P(gu),
where P(is) is a probability of the input sequence being a valid password, and
where P(gu) is a probability of a gesture pertaining to a user based on historical data collected from the user;
determining whether the security factor has reached a predetermined level; and
in response to determining that the security factor has reached the predetermined level, allowing access to the secure system before the entire input sequence is received.

8. The system of claim 7, wherein the operations further comprise:
determining the probability of the input sequence by calculating:
P(is)=N̂L
where N is a number of letters in a language, and L is a length of the input sequence.

9. The system of claim 7, wherein the probability of the gesture pertaining to the user is calculated by comparing ratios of at least one of different keystrokes, keystroke transitions, dwell times, and gestures to the historical data collected from the user.

10. The system of claim 7, wherein the operations further comprise:
determining the probability of the gesture pertaining to the user by calculating:
P(gu)=P(gu[i])*P(gu[i+1]) . . . *P(gu[n])
where n is a current key stroke,
where P(gu[i])=(Input_Range)/abs(diff(Mean_Authenticated_Input[i]−Current[i]+1),
where Input_Range is a normal time range for a particular keying gesture in users,
where Mean_Authenticated_Input[i] is a mean of successes in previous attempts keying this particular portion of the input sequence, and
where Current[i] is an actual time for keying this particular portion of the input sequence.

11. The system of claim 7, wherein the operations further comprise:
in response to determining that the security factor has not reached the predetermined level,
receiving another portion of the input sequence;
determining a new security factor of the received portion of the input sequence; and
in response to determining that the new security factor has reached the predetermined level, allowing access to the secure system before the entire input sequence is received.

12. The system of claim 7, wherein the operations further comprise:
determining that an entire input sequence has been entered and that the security factor for the entire input sequence has not reached the predetermined level; and
denying access to the secure system.

13. A computer program product for determining access to a secure system, the computer program product comprising:
a computer readable storage medium having computer readable program code embodied therewith, the computer readable program code comprising:
computer readable program code, when executed by a processor of a computer, configured to perform:
receiving a portion of an input sequence;
determining a security factor of the received portion of the input sequence by calculating:
P(is)*P(gu),
where P(is) is a probability of the input sequence being a valid password, and
where P(gu) is a probability of a gesture pertaining to a user based on historical data collected from the user;
determining whether the security factor has reached the predetermined level; and
in response to determining that the security factor has reached the predetermined level, allowing access to the secure system before the entire input sequence is received.

14. The computer program product of claim 13, wherein the computer readable program code, when executed by the processor of the computer, is configured to perform:
determining the probability of the input sequence by calculating:
P(is)=N̂L
where N is a number of letters in a language, and L is a length of the input sequence.

15. The computer program product of claim 13, wherein the probability of the gesture pertaining to the user is calculated by comparing ratios of at least one of different keystrokes, keystroke transitions, dwell times, and gestures to the historical data collected from the user.

16. The computer program product of claim 13, wherein the computer readable program code, when executed by the processor of the computer, is configured to perform:
determining the probability of the gesture pertaining to the user by calculating:
P(gu)=P(gu[i])*P(gu[i+1]) . . . *P(gu[n])
where n is a current key stroke,
where P(gu[i])=(Input_Range)/abs(diff(Mean_Authenticated_Input[i]−Current[i]+1),
where Input_Range is a normal time range for a particular keying gesture in users,
where Mean_Authenticated_Input[i] is a mean of successes in previous attempts keying this particular portion of the input sequence, and
where Current[i] is an actual time for keying this particular portion of the input sequence.

17. The computer program product of claim 13, wherein the computer readable program code, when executed by the processor of the computer, is configured to perform:
in response to determining that the security factor has not reached the predetermined level,
receiving another portion of the input sequence;
determining a new security factor of the received portion of the input sequence; and
in response to determining that the new security factor has reached the predetermined level, allowing access to the secure system before the entire input sequence is received.

18. The computer program product of claim 13, wherein the computer readable program code, when executed by the processor of the computer, is configured to perform:
determining that an entire input sequence has been entered and that the security factor for the entire input sequence has not reached the predetermined level; and
denying access to the secure system.
